(19) United States
(12) Patent Application Publication
(10) Pub. No.: US 2018/0319001 A1
(43) Pub. Date: Nov. 8, 2018

(54) Power Tool

(71) Applicant: Positec Power Tools (Suzhou) Co., Ltd., Suzhou (CN)

(72) Inventors: Hongfeng Zhong, Suzhou (CN); Yu Wu, Suzhou (CN); Yimin Sun, Suzhou (CN)

(21) Appl. No.: 16/034,739

(22) Filed: Jul. 13, 2018

Related U.S. Application Data
(63) Continuation of application No. PCT/CN2017/001045, filed on Jan. 13, 2017.

(30) Foreign Application Priority Data
Jan. 14, 2016 (CN) 201610024022.0

(51) Int. Cl. B25F 5/00; B25F 3/00

(52) U.S. Cl. CPC B25F 5/006; B23D 47/005; B25F 3/00

(57) ABSTRACT

The invention provides a power tool, including: a motor; an output shaft for mounting a work head, wherein a plane passing through an axis of the motor and an axis of the output shaft is defined as a reference plane; and a housing, including an inner housing and an outer housing, wherein the inner housing and the outer housing are spaced, and the motor is at least partially accommodated in the inner housing; a limiting mechanism and a vibration reduction mechanism disposed between the outer housing and the inner housing, and wherein the vibration reduction mechanism acts in a direction perpendicular to the reference plane, the limiting mechanism is used for limiting the outer housing to move relative to the inner housing in the reference plane or a plane parallel to the reference plane, and the limiting mechanism and the vibration reduction mechanism are respectively independent.

### BACKGROUND

### Technical Field

The present invention relates to a power tool.

### Related Art

A power tool, such as an oscillating power tool, usually includes a housing, a motor accommodated in the housing, an output shaft for mounting a work head, and an eccentric transmission mechanism connected between the motor and the output shaft. The eccentric transmission mechanism converts rotary movement of a motor shaft into oscillating movement of the output shaft around the axis per se. In this way, after a free end of the output shaft is connected to different accessory work heads, such as a straight saw blade, a circular saw blade, and a triangular dull polishing tray, the oscillating power tool may implement multiple operations such as sawing, cutting, polishing, and scraping, to adapt to different working requirements.

### SUMMARY

An objective of the present invention is directed to providing a power tool that is comfortable to operate and high in working efficiency.

According to the power tool of the present invention, a limiting mechanism and a vibration reduction mechanism are relatively independently disposed, and then the most appropriate material, shape, size and the like can be selected according to respective characteristics. Therefore, the vibration reduction effect is ensured without affecting working efficiency. Besides, the limiting mechanism and the vibration reduction mechanism are flexible to dispose, and the whole machine is compact in structure and better in man-machine interaction.

### BRIEF DESCRIPTION OF THE DRAWINGS

The foregoing objective, technical solutions, and beneficial effects of the present invention can be implemented by means of the following accompanying drawings.

FIG. 1 is a front view of an oscillating power tool according to a first implementation of the present invention;

FIG. 2 is a schematic diagram of the oscillating power tool shown in FIG. 1 with half of an outer housing removed;

FIG. 3 is a partial stereoscopic diagram of the oscillating power tool shown in FIG. 1;

FIG. 4 is a partial stereoscopic exploded view of the oscillating power tool shown in FIG. 1;

FIG. 5 is a sectional view along an A-A line in FIG. 1;

FIG. 6 is a schematic diagram of an oscillating power tool with half of an outer housing hidden according to a second implementation of the present invention;

FIG. 7 is a partial stereoscopic exploded view of the oscillating power tool shown in FIG. 6;

FIG. 8 is a sectional view of the oscillating power tool shown in FIG. 6;

FIG. 9 is a sectional view of an oscillating power tool according to a third implementation of the present invention;

FIG. 10 is a schematic diagram of an oscillating power tool with half of an outer housing hidden according to a fourth implementation of the present invention;

FIG. 11 is a partial stereoscopic exploded view of the oscillating power tool shown in FIG. 10; and

FIG. 12 is a sectional view of the oscillating power tool shown in FIG. 10.

### DETAILED DESCRIPTION

The present invention is further described in detail with reference to the accompanying drawings and specific implementations.

In the present implementation, an oscillating power tool is used as an example to illustrate a creative concept of the present invention, and the oscillating power tool is also referred to as an oscillating power tool. However, the power tool of the present invention is not limited to the oscillating power tool, and may also be a rotary power tool, such as a sanding machine or an angle grinder.

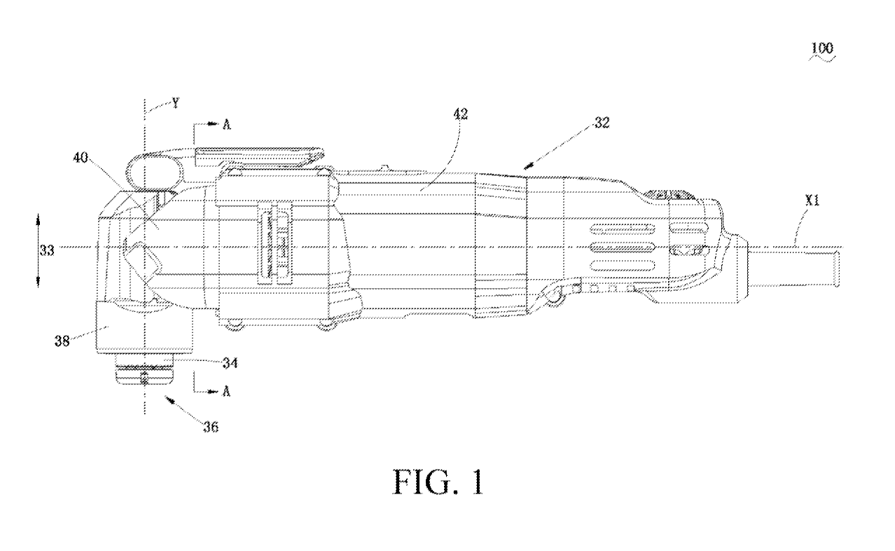

FIG. 1 to FIG. 5 show a first implementation of the present invention.

Referring to FIG. 1, an oscillating power tool 100 includes a housing 32, an output shaft 34 extending from the interior of the housing 32, a work head (not shown) mounted on a tail end of the output shaft 34, and a clamping component 36 used for clamping the work head in an axial direction 33 of the output shaft. The axial direction 33 approximately extends along an axis Y parallel to the output shaft 34.

The housing 32 includes an inner housing 38 and an outer housing 40 that are spaced. The outer housing 40 extends approximately along a straight line; a longitudinal extending axis of the outer housing 40 is X1, and the inner housing 38 partially bends and extends relative to the outer housing 40 from one end of the outer housing 40. The outer housing 40 has a holding area 42, and the user holds the holding area 42 in a process of guiding the tool.

A plane that the longitudinal extending axis X1 of the outer housing 40 and the axis Y of the output shaft pass through is defined as a middle plane, that is, when the longitudinal extending axis X1 of the outer housing 40 and the axis Y of the output shaft are coplanar, the middle plane is formed. In this embodiment, the longitudinal extending axis X1 of the outer housing 40 is approximately perpendicular to the axis Y of the output shaft. Those skilled in the art can conceive of that the longitudinal extending axis X1 of the outer housing 40 and the axis Y of the output shaft may not be coplanar or coplanar but not perpendicular. For example, the longitudinal extending axis X1 of the outer housing 40 and the axis Y of the output shaft are parallel or form other angles.

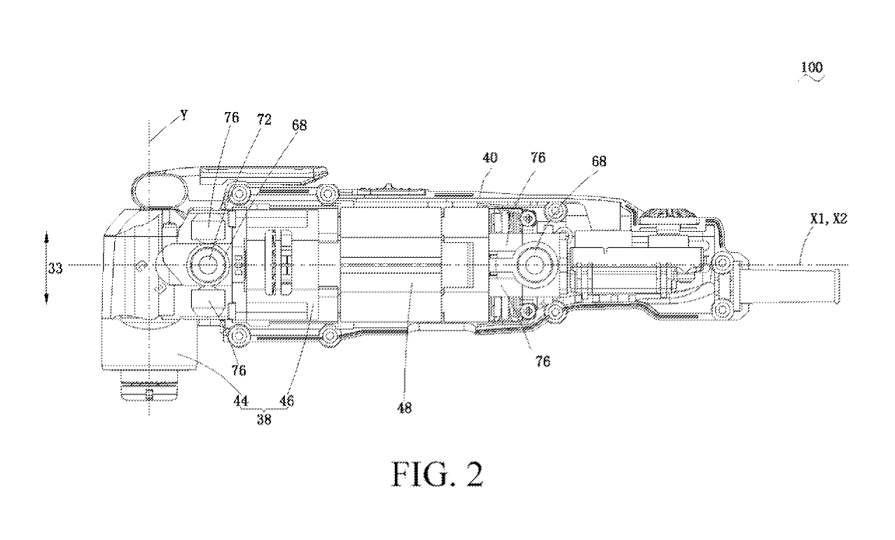

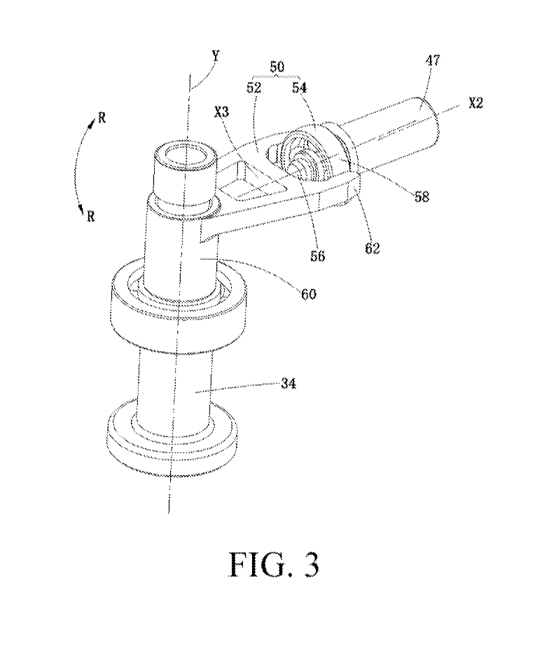

Referring to FIG. 2, the inner housing 38 includes a head housing 44 at least partially accommodating the output shaft 34 and a motor housing 46 connected to the head housing 44. The motor housing 46 is used for mounting the motor 48, and the motor 48 has a motor shaft 47 (referring to FIG. 3). The motor housing 46 may be designed to partially or completely cover the motor 48 according to requirements. In this embodiment, the head housing 44 is made of metal, and the motor housing 46 is made of plastic. Certainly, the head housing 44 and the motor housing 46 may be made of metal or plastic according to requirements. The motor housing 46 in this embodiment consists of two parts, which are respectively disposed on two ends of the motor 48 and partially cover the motor 48, and the middle part of the motor 48 is not covered in the motor housing 46. The motor housing 46 may also be integrally formed, and in this case, the motor housing 46 may completely cover the motor 48.

Referring to FIG. 3, an eccentric transmission mechanism 50 is disposed between the motor shaft 47 and the output shaft 34. A rotary movement of the motor 48 around an axis X2 of the motor 48 is converted into an oscillating movement of the output shaft 34 around an axis Y of the output shaft 34 by the eccentric transmission mechanism 50, and an oscillating direction is shown by an arrow R-R in the drawing. When a free end of the output shaft 34 is connected to different work head accessories, such as a straight saw blade, a circular saw blade, and a triangular dull polishing tray, the oscillating power tool may implement operations such as cutting or grinding.

A plane that the axis X2 of the motor and the axis Y of the output shaft pass through is defined as a reference plane, that is, when the axis X2 of the motor and the axis Y of the output shaft are coplanar, the reference plane is formed. In this embodiment, the axis Y of the output shaft is approximately perpendicular to the axis X2 of the motor. Those skilled in the art may conceive of that the axis X2 of the motor and the axis Y of the output shaft may not be coplanar or coplanar but not perpendicular. For example, the axis X2 of the motor and the axis Y of the output shaft are parallel or form other angles.

Certainly, in this embodiment, the axis X2 of the motor and the longitudinal extending axis X1 of the outer housing 40 overlap, and therefore, the reference plane and the middle plane overlap.

A plane formed by movement of the work head is defined as a working plane, specific to this embodiment, the oscillating of the work head (may be a straight saw blade, a circular saw blade, or the like) forms an oscillating plane perpendicular to the axis Y of the output shaft along with the output shaft 34. The oscillating plane may be considered as a plane formed by oscillating of any one straight line perpendicular to the output shaft 34 on the work head along with the output shaft 34. Therefore, the oscillating plane is perpendicular to the foregoing middle plane or reference plane. Certainly, those skilled in the art may also conceive of that for the rotary power tool, the work head rotates along with the output shaft to form a rotary plane.

Continuing to refer to FIG. 3, the eccentric transmission mechanism 50 is disposed in the head housing 44 and includes a shifting fork 52 and an eccentric component 54 connected to the motor shaft 47. The eccentric component 54 includes an eccentric shaft 56 connected to the motor shaft 47 and a drive wheel 58 mounted on the eccentric shaft 56. One end of the shifting fork 52 is connected to the top of the output shaft 34, and the other end matches the drive wheel 58 of the eccentric component 54. The shifting fork 52 includes a sleeve 60 sleeved on the output shaft 34 and a forklike part 62 horizontally extending from the top end of the sleeve 60 to the motor shaft 47 vertically. In the present implementation, the drive wheel 58 is a ball bearing, and has a spherical external surface matching the forklike part 62 of the shifting fork 52. The eccentric shaft 56 is eccentrically connected to the motor shaft 47, that is, an axis X3 of the eccentric shaft 56 does not overlap with the axis X1 of the motor shaft 47 and is radially offset from the axis X1 of the motor shaft 47 by a certain interval. The forklike part 62 of the shifting fork 52 covers two sides of the drive wheel 58 and gets in tight sliding contact with the outer surface of the drive wheel 58.

When the motor 48 drives the motor shaft 47 to rotate, the eccentric shaft 56 eccentrically rotates relative to the axis X2 of the motor under driving of the motor shaft 47, and further, the drive wheel 58 is driven to eccentrically rotate relative to the axis X2 of the motor. Under driving of the drive wheel 58, the shifting fork 52 oscillates relative to the axis Y of the output shaft, and further drives the output shaft 34 to oscillate around the axis Y per se. Oscillating of the output shaft 34 drives the work head mounted thereon to oscillate, so as to machine a workpiece.

In this embodiment, an oscillating angle of the output shaft 34 is 5°, and an oscillating frequency of the output shaft 34 is 18000 times per minute. By setting the oscillating angle of the output shaft to be 5°, working efficiency of the work head is greatly improved, and when the work head is a saw blade, chippings are convenient to discharge.

It needs to be pointed out that according to the oscillating power tool of the present invention, the oscillating angle of the output shaft 34 is not limited only to 5°, and may be set as a value greater than or less than 5° according to requirements. The oscillating frequency of the output shaft 34 is not limited to 18000 times per minute, either, and preferably greater than 10000 times per minute.

Since the housing 32 includes an inner housing 38 and an outer housing 40, in order to limit movement of the outer housing 40 relative to the inner housing, a limiting mechanism is disposed between the inner housing 38 and the outer housing 40. The limiting mechanism is mainly used to limit the outer housing 40 to move, relative to the inner housing 38, in the reference plane and a plane parallel to the reference plane. It needs to be pointed out that the movement of the outer housing and the inner housing mentioned herein is not necessary to be completely and precisely limited to the movement in the reference plane or the plane parallel to the reference plane. Because of complexity of an actual working condition, the reference plane may generate tiny overturn, and the movement limitation of the limiting mechanism to the outer housing and the inner housing also includes a case in which the reference plane has the tiny overturn. Further, it needs to be pointed out that the limited movement includes the movements and rotations in these planes.

In another case, the limiting mechanism is mainly used to limit the outer housing 40 to move relative to the inner housing 38 in the middle plane and the plane parallel to the middle plane. It needs to be pointed out that the movement of the outer housing and the inner housing mentioned herein is not necessary to be completely and precisely limited to the movement in the middle plane or the plane parallel to the middle plane. Because of complexity of an actual working condition, the middle plane may generate tiny overturn, and the movement limitation of the limiting mechanism to the outer housing and the inner housing also includes a case in which the middle plane has the tiny overturn. Further, it needs to be pointed out that the limited movement includes the movements and rotations in these planes.

In another case, the limiting mechanism is mainly used to limit the movement of the outer housing 40 relative to the inner housing 38 in a plane perpendicular to the oscillating plane or working plane and parallel to the axis of the output shaft or the longitudinal extending axis of the outer housing 40.

In this embodiment, the limiting mechanism is disposed between the head housing 44 and the outer housing 40, and between the motor housing 46 and the outer housing 40. Certainly, the limiting mechanism may also be disposed only between the head housing 44 and the outer housing 40 or only between the motor housing 46 and the outer housing 40.

A limiting mechanism is disposed on at least one side of the middle plane. In this embodiment, the limiting mechanisms are symmetrically disposed on two sides of the middle plane.

A case in which the limiting mechanism is located only between the head housing 44 and the outer housing 40 and located on one side of the middle plane is used as an example for specific illustration below.

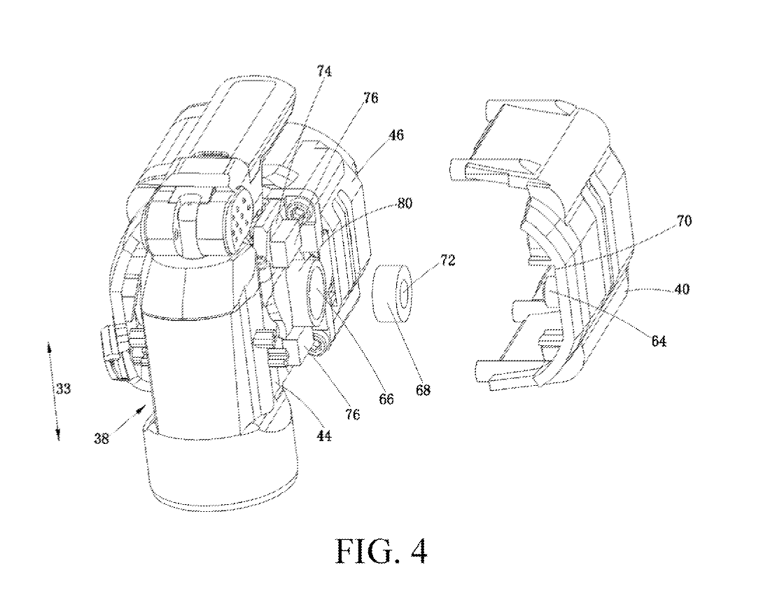

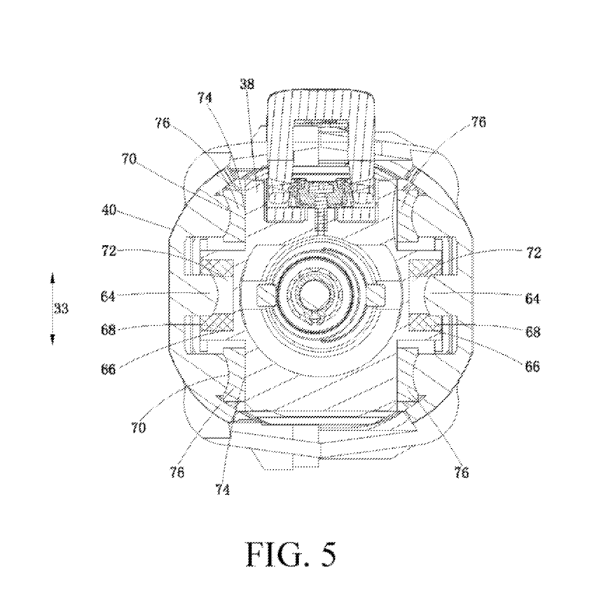

Referring to FIG. 4 and FIG. 5, the limiting mechanism includes a limiting member 64, a limiting groove 66 matching the limiting member 64, and a limiting damping member 68 disposed between the limiting member 64 and the limiting groove 66. The limiting member 64 is disposed on at least one of the head housing 44 and the outer housing 40 and the limiting groove 66 is disposed on the other one of the head housing 44 and the outer housing 40.

In this embodiment, the limiting member 64 is disposed on the outer housing 40, and extends to the head housing 44 from the inner surface 70 of the outer housing 40. The limiting member is a cylindrical pin, and is integrally formed on the outer housing 40. Certainly, the limiting member may also be fixedly disposed on the inner surface 70 of the outer housing 40.

The limiting groove 66 is disposed in the head housing 44, and is used to accommodate the limiting member 64. The limiting member 64 and the limiting groove 66 are circular, and in this way, a liming function is achieved in each direction of the reference plane or the middle plane. Similarly, transmission of vibration and the like may also be reduced in each direction of the reference plane or the middle plane.

Certainly, the shapes of the limiting member 64 and the limiting groove 66 are not limited to be circular, and may also be polygonal, oval, or the like. Besides, the shape of the limiting member may be different from that of the limiting groove.

The limiting damping member 68 is provided with an accommodating hole 72, which is a cylindrical hole for the cylindrical pin 64 to penetrate through. Certainly, the shape of the accommodating hole 72 may change along with the shape of the limiting member. In this embodiment, the accommodating hole 72 is a through hole. Certainly, the accommodating hole 72 may also have a bottom surface, but the cylindrical pin 64 does not need to contact the bottom surface of the accommodating hole 72.

Since the limiting damping member 68 does not need to provide a vibration reduction function in a direction perpendicular to the middle plane or the reference plane, in a direction perpendicular to the middle plane or the reference plane for the limiting member 64, that is, in the axial direction per se, the length of the limiting damping member 68 may be not greater than the depth of the limiting groove 66.

In a working process of the oscillating power tool 100, a workpiece generates a hinder force to feeding of the work head; then the work head transmits the force to the output shaft, and further transmits to the inner housing 38 from the output shaft; the force is transmitted to the outer housing 40 through the limiting damping member 68 between the inner housing and the outer housing, and further the force is transmitted to the hand of a user who holds the oscillating power tool 100 from the outer housing 40. Therefore, the limiting damping member 68 uses a material with relatively large rigidity, thus it is favorable to improve the operation performance of the oscillating power tool and convenient for the user to more easily operate the oscillating power tool to smoothly feed the work head.

In the working process of the oscillating power tool 100, a main vibration source exists in a direction parallel to the oscillating plane, and therefore, a vibration reduction mechanism is disposed between the inner housing 38 and the outer housing 40, and a main acting direction of the vibration reduction mechanism is parallel to the oscillating plane or the working plane. That is, the vibration reduction mechanism mainly acts in the direction perpendicular to the reference plane or the middle plane.

By disposing the vibration reduction mechanism, the vibration generated in the working process is effectively prevented from being transmitted to the outer housing 40 through the inner housing 38, and further prevented from being transmitted to the holding area 42. The vibration transmitted to the holding area 42 is reduced, and the problem of hand numbing caused by vibration in the use process of the user is greatly improved, and a comfort level in operation is improved.

In this embodiment, the vibration reduction mechanism is disposed between the head housing 44 and the outer housing 40 and between the motor housing 46 and the outer housing 40. Certainly, the vibration reduction mechanism may also be disposed only between the head housing 44 and the outer housing 40 or between the motor housing 46 and the outer housing 40.

The vibration reduction mechanism is disposed on at least one side of the middle plane. However, in this embodiment, the vibration reduction mechanisms are symmetrically disposed on two sides of the middle plane.

A case in which the vibration reduction mechanism is located between the head housing 44 and the outer housing 40 and located on one side of the middle plane is only used as an example for specific illustration below. Referring to FIG. 4 and FIG. 5, the vibration reduction mechanism includes a vibration reduction damping member 76 disposed between the head housing 44 and the outer housing 40.

Specifically, in this embodiment, the vibration reduction damping member 76 is disposed between the outer surface 74 of the inner housing 38 and the inner surface 70 of the outer housing 40. The number of the vibration reduction damping member 76 may be N (N is 1, 2 . . . and other integers), and in this embodiment, the number of the vibration reduction damping members 76 is two.

The vibration reduction damping member 76 can have a shape suitable for subsequent placing in a state of not being placed. For example, the vibration reduction damping member 76 is a cuboid in the state of not being placed and is changed in shape by using a prestress in the state of being placed. Therefore, the generation of the prestress may generate an extremely favorable influence on the interior of the vibration reduction damping member 76. The proper prestress is particularly between 20% and 40%, and preferably 35%.

The vibration reduction damping member 76 is connected to the inner surface 70 of the outer housing 40. The inner surface 70 contacting the vibration reduction damping member 76 of the outer housing 40 is machined into a support surface, which is approximately convex-shaped.

The vibration reduction damping member 76 is connected to the outer surface 74 of the inner housing 38. The outer surface 74 contacting the vibration reduction damping member 76 of the inner housing 38 is machined into a support surface, which is approximately planar.

In addition, the inner surface 70 contacting the vibration reduction damping member 76 of the outer housing 40 may be machined to be planar; the outer surface 74 contacting the vibration reduction damping member 76 of the inner housing 38 may be machined to be the support surface, which is approximately convex-shaped; or each of the outer surface 74 and the inner surface 70 may be machined into the support surface, which is planar.

Since the vibration reduction mechanism and the limiting mechanism are relatively independently disposed, the vibration reduction damping member 76 may be directly connected to the inner surface 70 of the outer housing 40 and the outer surface 74 of the inner housing 38. Besides, the vibration reduction damping member 76 may be manufactured into any shape fitted to the outer surface of the inner housing 38 and the inner surface of the outer housing 40 according to requirements.

In this embodiment, the vibration reduction damping member 76 is a cuboid in a state of not being placed, and is changed in shape under the action of the prestress after being placed, and a surface contacting the inner surface 70 of the outer housing 40 is recessed-shaped. Certainly, the limiting mechanism is mainly used to limit the outer housing 40 to move relative to the inner housing 38 in the reference plane or the middle plane; and the vibration reduction mechanism mainly plays a role in a direction perpendicular to the reference plane or the middle plane. Therefore, the vibration reduction mechanism and the limiting mechanism are relatively independently disposed. For example, the vibration reduction mechanism and the limiting mechanism may be adjacently or separately disposed. In this way, the most appropriate shapes, sizes, and materials of the vibration reduction damping member 76 and the limiting damping member 68 may be selected according to respective functions. Therefore, the vibration reduction effect is ensured without affecting the working efficiency.

The vibration reduction mechanism and the limiting mechanism are relatively independently disposed. Therefore, the vibration reduction mechanism is disposed on at least one side of the middle plane; when disposed on both sides, the vibration reduction mechanisms may be symmetrically disposed, and certainly, may also be disposed in a staggering manner. However, the position of the limiting mechanism is more flexibly disposed, and similar to the vibration reduction mechanism, the limiting mechanism may be disposed on one side or two sides of the middle plane; and more flexibly, the limiting mechanism may be partially located in the middle plane. Therefore, specific setting may be performed according to a specific shape of the oscillating power tool 100; besides, the diameter of the holding area 42 may be reduced, and the structure is more compact, to facilitate holding.

Then referring to FIG. 4 and FIG. 5, the case in which the limiting mechanism and the vibration reduction mechanism are located between the head housing 44 and the outer housing 40 and located on one side of the middle plane is still used as an example. In this embodiment, the vibration reduction mechanism and the limiting mechanism are adjacently disposed. The vibration reduction mechanism includes two vibration reduction damping members 76, and the limiting damping member 68 of the limiting mechanism is disposed between the two vibration reduction damping members 76. The two vibration reduction damping members 76 and the limiting damping member 68 are sequentially disposed along an axial direction 33 of the output shaft. The two vibration reduction damping members 76 are symmetrically disposed relative to the limiting damping member 68, and connecting lines of centers of the three extends along the axial direction 33 of the output shaft.

The vibration reduction damping members 76 and the limiting damping member 68 are spaced and do not interfere with each other. Specifically referring to FIG. 4, the vibration reduction damping members 76 and the limiting damping member 68 are spaced by an outer wall 80 (a part of the head housing 44) of the limiting groove 66. The vibration reduction damping members 76 and the outer wall 80 of the limiting groove 66 are spaced by a certain distance. Certainly, the vibration reduction damping members 76 may also contact the outer wall 80.

The vibration reduction damping members 76 and the limiting damping member 68 both have certain elasticity, and use polyurethane (PU), ethylene-propylene-diene monomer (EPDM), polypropylene (EPP), rubber, a mixture thereof, and the like. These materials are used between the inner housing 38 and the outer housing 40, and in combination with a proper prestress, the comfort level in operation is improved while the user holds the holding area 42 to guide the tool.

In this embodiment, both the vibration reduction damping members 76 and the limiting damping member 68 are preferably made of PU. Certainly, the vibration reduction damping members 76 and the limiting damping member 68 may also use different materials. For example, the vibration reduction damping members 76 use PU and the limiting damping member 68 use EPP, and the like.

The vibration reduction damping members 76 and the limiting damping member 68 use PU, and a density is generally 0.3 g/cm³ to 0.8 g/cm³. The density of the vibration reduction damping members 76 is preferably 0.45 g/cm³ to 0.55 g/cm³, and the density of the limiting damping member 68 is preferably 0.6 g/cm³ to 0.7 g/cm³. Therefore, the density of the vibration reduction damping members 76 and that of the limiting damping member 68 may be the same, but may also be different to some extent. Preferably, a material density of the vibration reduction damping members 76 is less than that of the limiting damping member 68.

Besides, the vibration reduction damping members 76 and the limiting damping member 68 are spaced. Therefore, the vibration reduction damping members 76 and the limiting damping member 68 may be the same or different in shape, size or number according to requirements.

For example, in this embodiment, in a state of not being placed between the outer surface 74 of the inner housing 38 and the inner surface 70 of the outer housing 40, the vibration reduction member 76 is approximately a cuboid, but after being placed, one surface contacting the inner surface 70 of the outer housing 40 is approximately recessed-shaped, but the limiting damping member 68 is approximately cylindrical in both states of being placed and not being placed. In addition, the size and the number are both different. Certainly, the shape and the number of the vibration reduction damping members 76 and the limiting damping member 68 are not limited only to this embodiment, and may be set according to a specific space.

In this embodiment, the two vibration reduction damping members 76 are spaced by a certain distance, and in this way, a span of the vibration reduction mechanism in the axial direction 33 of the output shaft is increased; a greater span indicates a better vibration reduction effect, and meanwhile, the vibration reduction mechanism provides enough support for the head housing 44 in the axial direction 33 of the output shaft, and a movement angle of the head housing 44 relative to the outer housing 40 is relatively small, and reduction of working efficiency is obviously avoided.

Preferably, a maximal length of the head housing 44 for accommodating part of the output shaft 34 along the axial direction 33 of the output shaft is L; a distance L1 (span) between two farthest points of the two vibration reduction damping members 76 along the axial direction 33 of the output shaft is greater than or equal to 0.2 L and less than or equal to 0.8 L. Preferably, the distance L1 between two farthest points of the two vibration reduction damping members 76 along the axial direction 33 of the output shaft is greater than or equal to 0.4 L and less than or equal to 0.7 L. Preferably, the distance L1 between two farthest points of the two vibration reduction damping members 76 along the axial direction 33 of the output shaft is 0.5 L or 0.6 L.

Certainly, a sum L2 of the lengths of the two vibration reduction damping members 76 along the axial direction 33 of the output shaft is greater than or equal to 0.2 L and less than or equal to 0.8 L, so that a good vibration reduction effect may also be achieved and reduction of working efficiency is obviously avoided. Preferably, the sum L2 of the lengths of the two vibration reduction damping members 76 along the axial direction 33 of the output shaft is greater than or equal to 0.3 L and less than or equal to 0.6 L. Preferably, the sum L2 of the lengths of the two vibration reduction damping members 76 along the axial direction 33 of the output shaft is 0.4 L or 0.5 L.

Referring to FIG. 2 again, in this embodiment, the vibration reduction mechanism and the limiting mechanism disposed between the motor housing 46 and the outer housing 40 are basically the same as those disposed between the head housing 44 and the outer housing, and a difference lies in that lines connecting centers of the two vibration reduction damping members 76 and the limiting damping member 68 are not located on the same straight line, and the lines connecting the three centers form a triangle. Such arrangement may also ensure that the working efficiency is not affected when the vibration reduction effect is ensured. In addition, the vibration reduction damping members 76 may also have a shape different from the cuboid shape in the head housing 44, for example, a cuboid with one or more angles cut off. Thus, it can be seen that the positions of the vibration reduction damping members 76 and the limiting damping member 68 are flexibly disposed and may be disposed according to a specific shape of the oscillating power tool 100, and the structure is more compact.

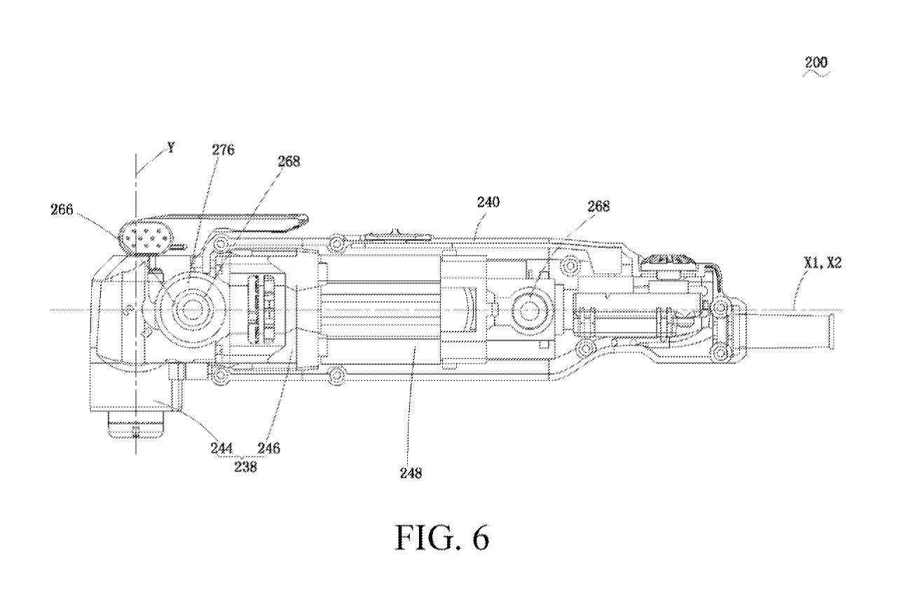

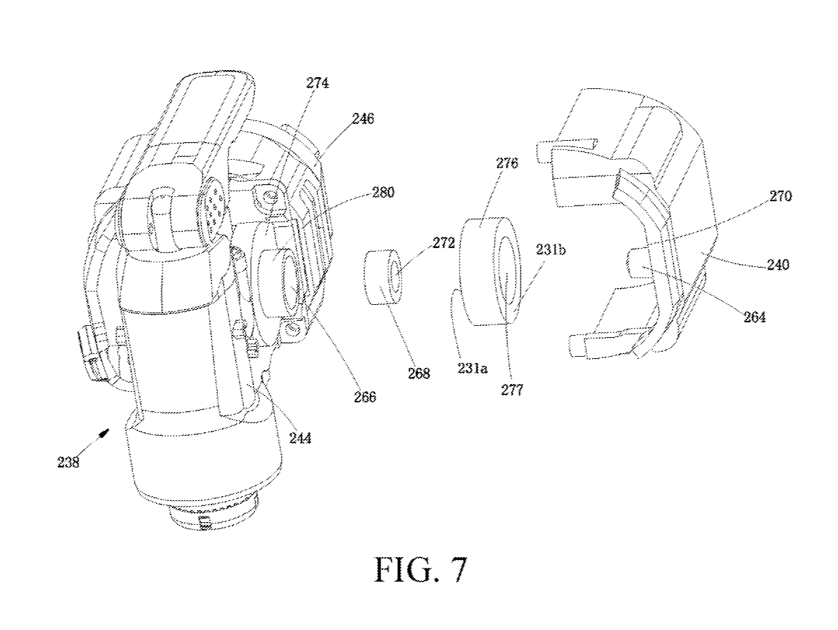

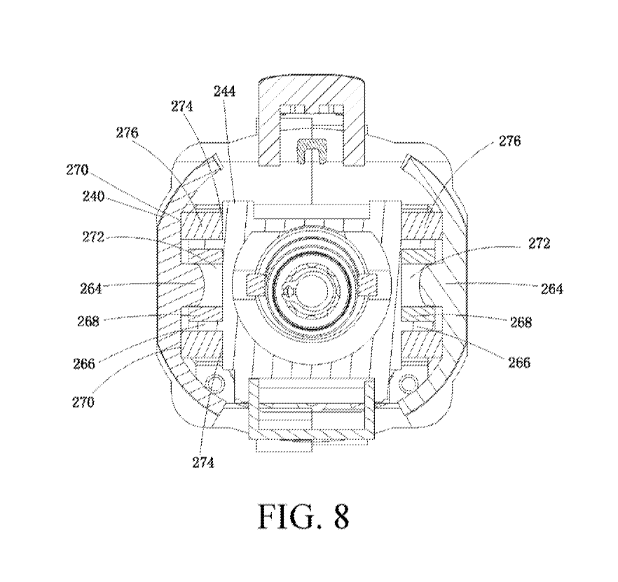

FIG. 6 to FIG. 8 show a second implementation of the present invention.

As shown in FIG. 6 to FIG. 8, this embodiment is approximately similar to the first embodiment. In this embodiment, an oscillating power tool 200 and its general layout and limiting mechanism are all the same as those in the first embodiment, and the difference lies in the setting of the vibration reduction mechanism. In the present implementation, a vibration reduction mechanism is disposed between a head housing 244 and an outer housing 240 and a vibration reduction mechanism is also disposed between a motor housing 246 and the outer housing 240. Besides, the vibration reduction mechanisms are symmetrically disposed on two sides of a middle plane.

A case in which the vibration reduction mechanism is located between the head housing 244 and the outer housing 240 and located on one side of the middle plane is used as an example for illustration below. The vibration reduction mechanism includes a vibration reduction damping member 276. The vibration reduction damping member 276 is in an approximately annular cylindrical structure, and two bottom surfaces of a cylinder are a first bottom surface 231a and a second bottom surface 233b of the vibration reduction damping member 276. The vibration reduction damping member 276 includes an inner hole 277, and the inner hole 277 is approximately cylindrical and has an inner side wall.

Further, the vibration reduction damping member 276 is sleeved on an outer wall 280 of a limiting groove 266. Specifically, the inner side wall of the vibration reduction damping member 276 is engaged with the outer wall 280 of the limiting groove 266, so as to limit a relative position relationship between the vibration reduction damping member 276 and the head housing 244, and prevent the vibration reduction damping member 276 from being offset to other positions upon a repeated vibration action in the working process of the oscillating power tool 200.

Further, the first bottom surface 231a of the vibration reduction damping member 276 abuts against the head housing 244, and the second bottom surface 233b of the vibration reduction damping member 276 abuts against the outer housing 240. More specifically, the first bottom surface 231a abuts against the outer surface 274 of the head housing 244, and the second bottom surface 233b abuts against the inner surface 270 of the outer housing 240. Preferably, the part abutting against the first bottom surface 231a of the outer surface 274 is planar, and the part abutting against the second bottom surface 233b of the inner surface 270 is also planar. More preferably, the vibration reduction damping member 276 and the inner surface 270 of the outer housing 240 are relatively freely disposed, so that a relative position relationship between the vibration reduction damping member 276 and the outer housing 240 is not limited. Because of such setting, in a working process of the oscillating power tool 200, forces applied to the vibration reduction damping member 276 in directions other than the direction perpendicular to the middle plane may be reduced, so that fatigue failure of the vibration reduction damping member 276 is alleviated and the service life of the vibration reduction damping member 276 is prolonged.

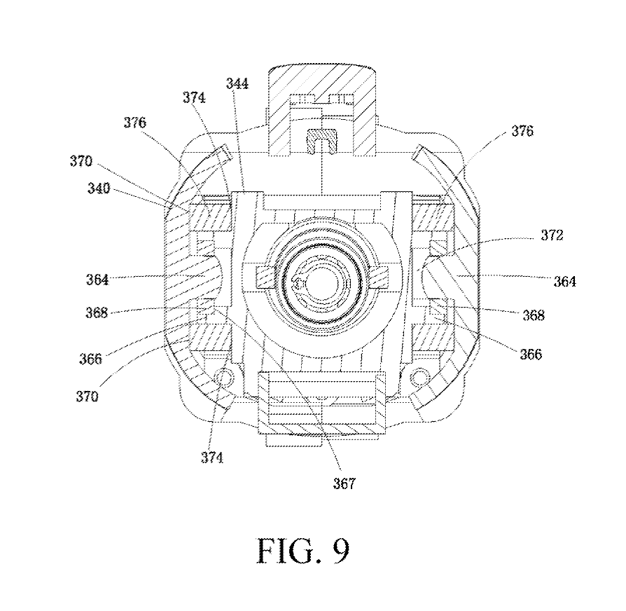

FIG. 9 is a third implementation of the present invention, and is a deformation based on the second implementation. In this embodiment, the interior of a limiting groove 366 is provided with a step surface 367, that is, an inner wall of the limiting groove 366 is divided into two sections with two different inner diameters. Further, the inner diameter of one section close to a head housing 344 of the inner wall of the limiting groove 366 is relatively small, and the inner diameter of one section close to an outer housing 340 is relatively large. Further, a limiting damping member 368 is disposed in the section close to the outer housing 340 in the limiting groove 336. The limiting damping member 368 is approximately annular cylindrical, and has a through accommodating hole in the middle, and the accommodating hole is approximately cylindrical. Further, a limiting member 364 disposed on the outer housing 340 is also in an approximately cylindrical shape protruding from an inner surface 370 of the outer housing 340. After assembly, the limiting member 364 is engaged into the accommodating hole of the limiting damping member 368. Specifically, the limiting member 364 completely penetrates through the accommodating hole of the limiting damping member 368.

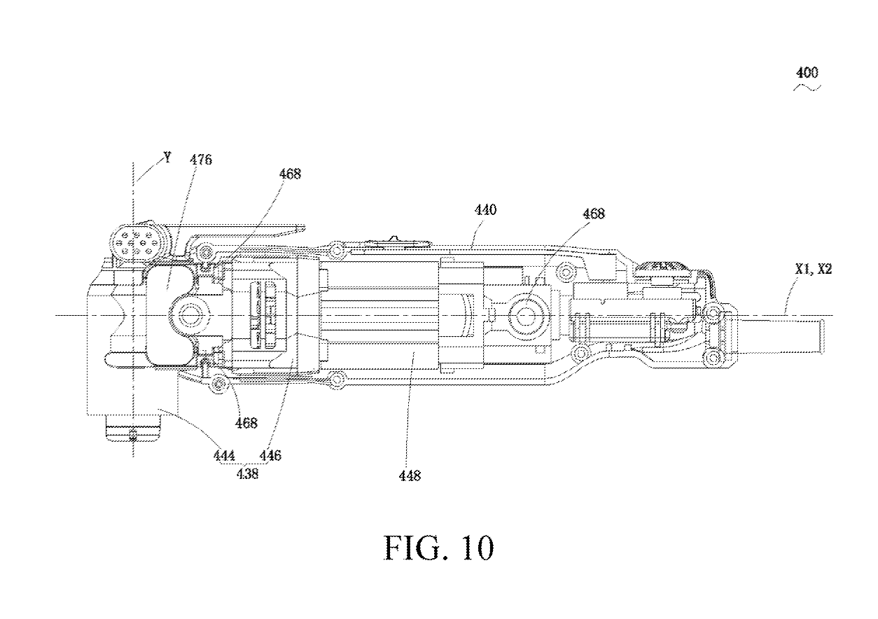

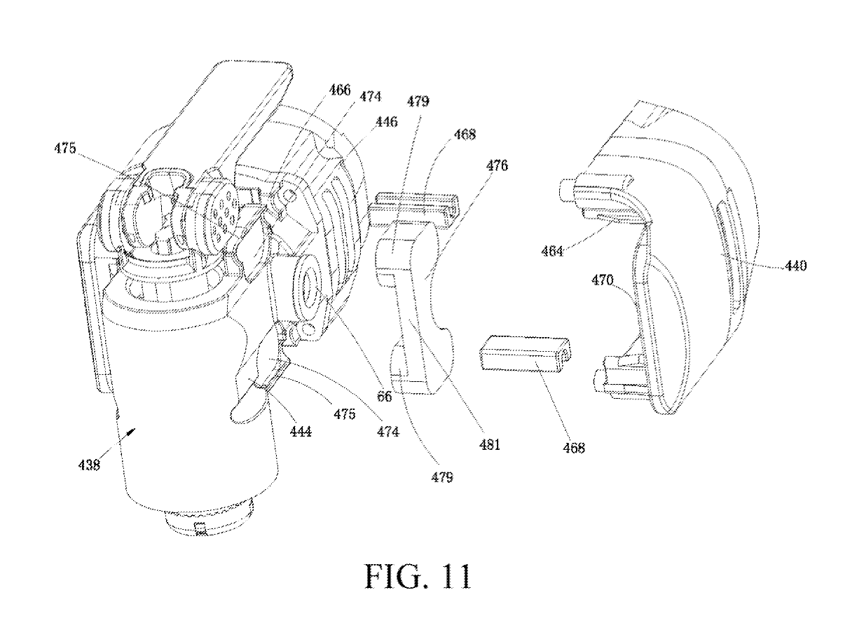

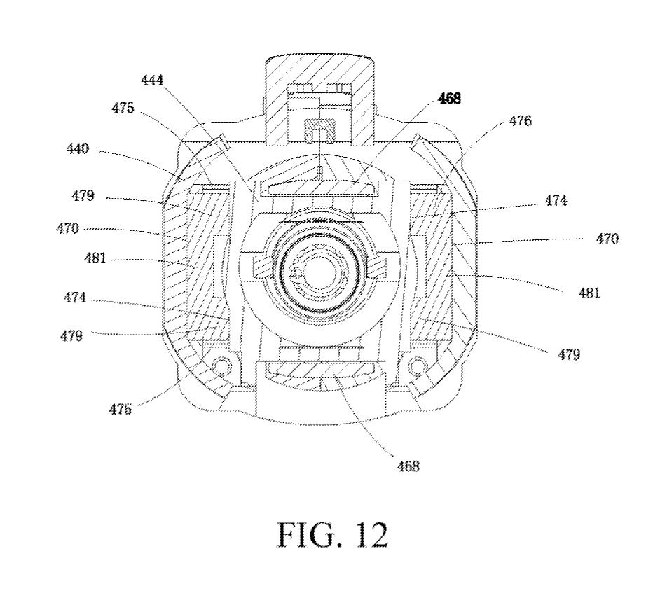

FIG. 10 to FIG. 12 show a fourth implementation of the present invention.

Referring to FIG. 10 to FIG. 12, this embodiment is approximately similar to the first embodiment. In this embodiment, an oscillating power tool 400 and its general layout are the same as those in the first embodiment. In the present implementation, a vibration reduction mechanism and a limiting mechanism are disposed between a head housing 444 and an outer housing 440. Further, the vibration reduction mechanisms are symmetrically disposed on two sides of a middle plane.

A case in which the vibration reduction mechanism is located between the head housing 444 and the outer housing 440 and located on one side of the middle plane is used as an example for illustration below. The vibration reduction mechanism includes a vibration reduction damping member 476. The vibration reduction damping member 476 is disposed between an outer surface 474 of the head housing 444 and an inner surface 470 of the outer housing 440. Specifically, the head housing 444 is provided with a flange 475 protruding from the outer surface 474, and the flange 475 encircles on the outer surface 474 of the head housing 444 to form an accommodating space. Preferably, two flanges 475 and two accommodating spaces are respectively disposed along an axial direction. Preferably, the vibration reduction damping member 476 includes two vibration reduction parts 479, which are disposed along the axial direction at intervals and are connected by a connecting part 481. Further, the two vibration reduction parts 479 are respectively disposed in the two accommodating spaces. Because of such setting, a length requirement of the vibration reduction damping member in the axial direction can be met without mounting two vibration reduction damping members, and the assembly process is simplified. Further, the part abutting against the inner surface 470 of the outer housing 440 of the vibration reduction damping member 476 is a plane, and the two are relatively freely disposed, so that a relative position relationship between the vibration reduction damping member 476 and the outer housing 440 is not limited. Such setting also aims to prolong service life of the vibration reduction damping member 476.

Further, a limiting mechanism is further disposed between the head housing 444 and the outer housing 440. A longitudinal extending axis of the outer housing 440 is X1, and an axis of an output shaft is Y. The longitudinal extending axis X1 of the outer housing is perpendicular to the axis Y of the output shaft. A plane, which is perpendicular to the axis of the output shaft and which the longitudinal extending axis X1 passes through is a transverse plane. In this embodiment, the limiting mechanisms are symmetrically disposed on two sides of the transverse plane. A case in which the limiting mechanism is located between the head housing 444 and the outer housing 440 and located on one side of the middle plane is used as an example for illustration below. The limiting mechanism includes a limiting damping member 468. The limiting damping member 468 has a cylindrical structure with an approximately U-shaped cross section. The U-shaped cylindrical structure of the limiting damping member 468 extends along a direction perpendicular to the middle plane. A recessed part of the U-shaped cylindrical structure of the limiting damping member 468 is disposed toward the outer housing 440. The outer housing 440 is provided with a limiting member 464. The limiting member 464 is disposed in a manner of protruding outwards from the inner surface 470 of the outer housing 440 and is used to be engaged with the recessed part of the limiting damping member 468. The head housing 444 is further provided with a limiting groove 466. The limiting damping member 464 is clamped in the limiting groove 466. The limiting damping member 464, the limiting groove 466 and the limiting member 464 collaborate with each other to limit movement of the inner and outer housings along the direction of the longitudinal extending axis X1 and the direction of the axis Y of the output shaft. Because of such setting of the limiting mechanism, the length along the direction perpendicular to the middle plane is longer, so that a limiting effect of the limiting damping member is better.

The limiting function of the limiting mechanism to relative movement between the inner housing and the outer housing in the foregoing second to fourth implementations is the same as that in the first implementation, and therefore, if a material with relatively large rigidity is used, the operation performance of the oscillating power tool can be improved, so that the user can more easily operate the oscillating power tool to smoothly feed the work head. Moreover, the vibration reduction mechanism can also provide a vibration reduction force in the direction the same as that of the vibration reduction mechanism in the first implementation, that is, an action direction of the vibration reduction mechanism is the same as the action direction of the vibration reduction mechanism in the first implementation, and therefore, the vibration of the oscillating power tool in an oscillating direction can be effectively reduced.

In the foregoing implementations, the limiting mechanism and the vibration reduction mechanism are relatively independently disposed. In this way, the most appropriate shapes, sizes, materials, numbers, and the like of the vibration reduction damping member and the limiting damping member may be selected according to respective functions thereof.

Therefore, the vibration reduction effect is ensured without affecting the working efficiency. Besides, the vibration reduction damping member and the limiting damping member are more flexible to dispose, and the oscillating power tool is more compact in structure and better in man-machine interaction.

The present invention is not limited to the implementations in the foregoing embodiments, and those skilled in the art may possibly make other changes in light of the teaching of the technical essence of the present invention, and the changes should fall within the protection scope of the present invention as long as the functions implemented by the changes are the same as or similar to those of the present invention.

What is claimed is:

1. A power tool, comprising:
a motor;
an output shaft for mounting a work head, wherein the output shaft is driven by the motor, and a plane passing through an axis of the motor and an axis of the output shaft is defined as a reference plane;
a housing, comprising an inner housing and an outer housing, wherein the inner housing and the outer housing are spaced, and the motor is at least partially accommodated in the inner housing; and
a limiting mechanism and a vibration reduction mechanism disposed between the outer housing and the inner housing, and wherein the vibration reduction mechanism acts in a direction perpendicular to the reference plane, the limiting mechanism is used for limiting the outer housing to move relative to the inner housing in the reference plane or a plane parallel to the reference plane, and the limiting mechanism and the vibration reduction mechanism are respectively independent.

2. The power tool according to claim 1, wherein the limiting mechanism comprises a limiting damping member, the vibration reduction mechanism comprises a vibration reduction damping member, and material of the limiting damping member is different from that of the vibration reduction damping member.

3. The power tool according to claim 1, wherein the limiting mechanism comprises a limiting damping member, the vibration reduction mechanism comprises a vibration reduction damping member, and the limiting damping member is different from the vibration reduction damping member in at least one of the shape and size.

4. The power tool according to claim 1, wherein the limiting mechanism comprises a limiting damping member, the vibration reduction mechanism comprises a vibration reduction damping member, and the density of the limiting damping member is different from that of the vibration reduction damping member.

5. The power tool according to claim 2, wherein the vibration reduction damping member is disposed between an outer surface of the inner housing and an inner surface of the outer housing.

6. The power tool according to claim 5, wherein the vibration reduction damping member is directly connected to the outer surface of the inner housing.

7. The power tool according to claim 6, wherein the vibration reduction damping member is directly connected to the inner surface of the outer housing.

8. The power tool according to claim 1, wherein the limiting mechanism comprises a limiting member, a limiting groove cooperating with the limiting member, and a limiting damping member disposed between the limiting member and the limiting groove, and the limiting member is disposed on one of the outer housing and the inner housing; and the limiting groove is disposed on the other one of the outer housing and the inner housing.

9. The power tool according to claim 8, wherein the limiting member is a cylindrical pin.

10. The power tool according to claim 9, wherein in an axial direction of the cylindrical pin, the length of the limiting damping member is not greater than the depth of the limiting groove.

11. The power tool according to claim 9, wherein the limiting damping member is provided with a through hole for the cylindrical pin to penetrate through.

12. The power tool according to claim 1, wherein the inner housing comprises a head housing at least partially accommodating the output shaft and a motor housing connected to the head housing, and the limiting mechanism and the vibration reduction mechanism are disposed between the head housing and the outer housing.

13. The power tool according to claim 12, wherein the limiting mechanism and the vibration reduction mechanism are disposed between the motor housing and the outer housing.

14. A power tool, comprising:
a motor;
an output shaft for mounting a work head, wherein the output shaft is driven by the motor;
a housing, comprising an inner housing and an outer housing, wherein the inner housing and the outer housing are spaced, and the motor is at least partially accommodated in the inner housing, the outer housing has a longitudinal extending axis, and a plane passing through an axis of the output shaft and the longitudinal extending axis is defined as a middle plane; and
a limiting mechanism and a vibration reduction mechanism disposed between the outer housing and the inner housing, and wherein the vibration reduction mechanism acts in a direction perpendicular to the middle plane, the limiting mechanism comprises a limiting damping member, and the vibration reduction mechanism comprises a vibration reduction damping member, and the vibration reduction damping member and the limiting damping member are respectively independent.

15. The power tool according to claim 14, wherein the limiting mechanism is used for limiting the outer housing to move relative to the inner housing in the middle plane or a plane parallel to the middle plane.

16. A power tool, comprising
a motor;
an output shaft for mounting a work head, wherein the output shaft is driven by the motor to oscillate around an axis of the output shaft, and a plane vertical to the axis of the output shaft is defined as an oscillating plane;
a housing, comprising an inner housing and an outer housing, wherein the inner housing and the outer housing are spaced, and the motor is at least partially accommodated in the inner housing; and
a limiting mechanism and a vibration reduction mechanism disposed between the outer housing and the inner housing, and wherein the vibration reduction mechanism acts in a direction parallel to the oscillating plane, the limiting mechanism is used for limiting the outer housing to move relative to the inner housing in a plane vertical to the oscillating plane and parallel to the axis of the output shaft, and the limiting mechanism and the vibration reduction mechanism are respectively independent.

17. The power tool according to claim 16, wherein the limiting mechanism comprises a limiting damping member, the vibration reduction mechanism comprises a vibration reduction damping member, and material of the limiting damping member is different from that of the vibration reduction damping member.

18. The power tool according to claim 16, wherein the limiting mechanism comprises a limiting damping member, the vibration reduction mechanism comprises a vibration reduction damping member, and the limiting damping member is different from the vibration reduction damping member in at least one of the shape and size.

19. The power tool according to claim 16, wherein the limiting mechanism comprises a limiting member, a limiting groove cooperating with the limiting member, and a limiting damping member disposed between the limiting member and the limiting groove, and the limiting member is disposed on one of the outer housing and the inner housing; and the limiting groove is disposed on the other one of the outer housing and the inner housing.

20. The power tool according to claim 19, wherein the limiting member is a cylindrical pin.
